(19) United States
(12) Patent Application Publication
(10) Pub. No.: US 2026/0084923 A1
(43) Pub. Date: Mar. 26, 2026

(54) ELEVATOR SYSTEM COMPRISING A PASSENGER DETECTION SYSTEM

(71) Applicant: Otis Elevator Company, Farmington, CT (US)

(72) Inventors: Gabriel Vaudour, Gien (FR); Bruno Quaretti, Gien (FR); Tony Huron, Gien (FR); Cristina Yusta, Leganes (ES); Mario Marcos, Leganes (ES)

(21) Appl. No.: 19/338,019

(22) Filed: Sep. 24, 2025

(30) Foreign Application Priority Data
Sep. 25, 2024 (EP) 24383025.4

(51) Int. Cl. B66B 5/00; B66B 3/00

(52) U.S. Cl. CPC B66B 5/0012; B66B 3/002

(57) ABSTRACT

An elevator system includes an elevator car for travelling along a hoistway between a plurality of landings and passenger detection system. The passenger detection system includes at least one passenger detector configured for detecting the presence of at least one passenger in a detection range; and at least one indicator device. The at least one indicator device is configured for receiving a detection signal from the at least one passenger detector indicating the presence of at least one passenger in the detection range of the at least one passenger detector, and for outputting a notification indicating that at least one passenger is present in the detection range of the at least one passenger detector in response to receiving the detection signal from the at least one passenger detector.

### FOREIGN PRIORITY

This application claims priority to European Patent Application No. 24383025.4, filed Sep. 25, 2024, and all the benefits accruing therefrom under 35 U.S.C. § 119, the contents of which in its entirety are herein incorporated by reference.

### TECHNICAL FIELD OF INVENTION

The invention relates to an elevator system comprising a passenger detection system for detecting and indicating the presence of at least one passenger in an elevator car and/or at the landings of an elevator system. The invention further relates to methods of detecting and indicating the presence of at least one passenger in an elevator car and/or at the landings of an elevator system.

### BACKGROUND OF THE INVENTION

An elevator system typically comprises at least one elevator car that is configured for moving along a hoistway extending between a plurality of landings. Passengers traveling within the elevator car are not aware whether there are further passenger waiting at the landings of the elevator system. Similarly, passengers waiting at the landings do not know whether there are passengers in an approaching elevator car.

It may be beneficial to provide an elevator system and methods that allow for informing passengers within an elevator car whether there are further passengers waiting at the landings of the elevator system. Similarly, it would be beneficial to be able to inform passengers waiting at the landings of an elevator system whether there are already passengers in an approaching elevator car.

### SUMMARY OF THE INVENTION

According to an exemplary embodiment of the invention, an elevator system comprises an elevator car that is configured for traveling along a hoistway between a plurality of landings; and a passenger detection system that is configured for detecting and indicating the presence of passengers with the elevator car and/or at the landings of the elevator system.

The passenger detection system includes at least one passenger detector and at least one indicator device. The at least one passenger detector is configured for detecting the presence of at least one passenger in a detection range of the at least one passenger detector and for providing a detection signal if it detects the presence of at least one passenger in the detection range of the at least one passenger detector. The at least one indicator device is configured for receiving the detection signal indicating the presence of at least one passenger from the at least one passenger detector. The at least one indicator device is further configured for outputting a notification indicating that at least one passenger is present in the detection range of the at least one passenger detector in response to receiving the detection signal from the at least one passenger detector.

The at least one passenger detector is located in the elevator car and/or at at least one of the landings of the elevator system. The at least one indicator device is located at the other one of the elevator car and/or the at least one of the landings of the elevator system. In consequence, the detection signal is transmitted from the at least one of the landings to the elevator car and/or from the elevator car to the at least one of the landings.

An elevator system according to an exemplary embodiment of the invention that is equipped with a passenger detection system allows for reliably detecting and indicating the presence of passengers in the elevator car to passengers that are waiting at the landings of the elevator system and/or reliably detecting and indicating the presence of passengers at the landings to passengers that are present in the elevator car. An elevator system according to an exemplary embodiment of the invention may be implemented at low costs, as it does not need cameras to be installed in the elevator car and/or at the landings.

An elevator system according to an exemplary embodiment of the invention also does not need to be equipment with any windows, glass doors or walls made of glass in order to allow passenger within the elevator car to see whether there are passengers at the landing and vice versa.

Since in an elevator system according to an exemplary embodiment of the invention, no pictures need to be transmitted between the elevator car and the landings, the detection signals transmitted between the landings and the elevator car need to comprise only small amounts of data. In consequence, the detection signals may be transmitted fast over inexpensive data connections providing only a small bandwidth.

In the following, a number of optional features of an elevator system according to exemplary embodiments of the invention are set out. These features may be realized in particular embodiments, alone or in combination with any of the other features, unless explicitly stated otherwise.

The passenger detection system may comprise an elevator car passenger detector that is located in the elevator car and configured for detecting that at least one passenger is present in the elevator car, and at least one landing indicator device that is located at the at least one of the landings and configured for indicating that at least one passenger is present in the elevator car; wherein the passenger detection system further comprises at least one landing passenger detector that is located at at least one of the landings and configured for detecting that at least one passenger is present at the at least one of the landings, and an elevator car indicator device that is located in the elevator car and configured for indicating that at least one passenger is present at the at least one of the landings.

Such a passenger detection system allows for detecting and indicating the presence of passengers in the elevator car to passengers that are present at the landings as well as detecting and indicating the presence of passengers that are present at the landings to passengers in the elevator car.

The passenger detector may communicate with the indicator devices using bidirectional or unidirectional communication.

In an elevator system according to an exemplary embodiment of the invention, every landing of the plurality of landings may be provided with a passenger detector in order to allow detecting the presence of passenger at each of the plurality of landings.

Additionally or alternatively every landing of the plurality of landings may be provided with an indicator device in order to allow indicating the presence of passenger in the elevator car at each of the plurality of landings.

Alternatively, in order to reduce the cost, only a selected number of landings of the plurality of landings may be provided with a passenger detector and/or with an indicator device. A passenger detector and/or an indicator device may in particular be provided only at a single landing, for example at the lowest landing, which may be considered to be the most important landing.

The at least one passenger detector may comprise a motion detector for detecting the presence of the at least one passenger in the elevator car or at the respective landing, respectively.

The at least one passenger detector may comprise an infrared detector for detecting infrared radiation that is emitted by at least one passenger being present in the elevator car or at the respective landing, respectively.

The at least one passenger detector may in particular comprise a combined motion and infrared detector in order to enhance the reliability of the detection signals provided by the at least one passenger detector.

The infrared detector may configurable to detect only human beings in an ambient temperature in the range from −10° C. to 60° C. The infrared detector may also be able to detect human beings through some plastic material, allowing the infrared detector to be places behind such plastic material.

The at least one passenger detector may be a thermal MOS detector (TMOS detector). A TMOS detector is an active and uncooled sensor that is able to detect the thermal radiation emitted by an object located in the field of view of the sensor. A TMOS detector provides a very reliable detector for detecting the presence of at least one passenger in the elevator car or at a landing. A TMOS detector may have small dimensions and may be provided at low costs.

The elevator system may comprise at least one box, in particular a dedicated passenger detection system box, wherein each box accommodates one of the at least one passenger detectors and/or one of the at least one indicator devices, respectively. Such a box may protect the passenger detector and/or an indicator device from adverse external influences, in particular from mechanical impact, water, moisture and/or dirt.

The at least one box may be located in the elevator car or at the respective landing.

Adding such boxes housing a passenger detector and an indicator device to an elevator system may be the easiest and fastest way of equipping an elevator system with a passenger detection system. Adding such boxes to an elevator system may in particular allow for retrofitting an existing elevator system with a passenger detection system.

The at least one passenger detector and/or the at least one indicator device may be located in an elevator control panel located in the elevator car or at the respective landing.

The at least one passenger detector and/or the at least one indicator device may in particular be located in a frame or in a display portion of a display provided in the elevator car or at the respective landing.

Providing the at least one passenger detector and/or the at least one indicator device in an elevator control panel or in a frame of a display provided in the elevator car or at the respective landing allows for equipping the elevator system with a passenger detection system without altering the visual appearance of the landings and of the elevator car. This may be considered as beneficial from an aesthetic point of view.

Integrating the passenger detectors and the indicator devices into a control devices may further allow for reducing the amount of wiring that is needed for wiring the passenger detectors and the indicator devices. Reducing the amount of wiring may facilitate the installation of the passenger detectors and the indicator device. It may further reduce the costs of installation.

The at least one passenger detector and the at least one indicator device may be coupled with each other by a wired data connection that is configured for transmitting the detection signal from the at least one passenger detector to the at least one indicator device. The wired data connection may in particular include a communication bus, for example a CAN bus.

A wired data connection, such as a communication bus, provides a reliable data connection, which may be implemented at low costs.

The passenger detection system may use a data connection that is originally provided in the elevator system other purposes, for example a communication bus, which may include a CAN bus, that is configured for transmitting control signals and/or for allowing communicating with and between safety relevant components of the elevator system.

The at least one passenger detector and the at least one indicator device may be configured for transmitting the detection signal from the at least one passenger detector to the at least one indicator device via a wireless data connection. The wireless data connection may in particular include a WLAN connection or a Bluetooth connection.

The WLAN connection may in particular be configured to use any of the communication protocols specified in the IEEE-802.11 family, which is also known as “WiFi”.

A Bluetooth connections may in particular be configured for using the Bluetooth Low Energy (“Bluetooth BLE”) standard.

Using a wireless data connection may facilitate the installation of the passenger detectors and the indicator devices, as no additional wiring needs to be installed in the elevator system. Employing a wireless data connection may in particular facilitate adding a passenger detection system to an existing elevator system with.

The at least one indicator device may be configured for outputting an optical signal and/or for outputting an acoustic signal for indicating the presence of at least one passenger in the detection range of the at least one passenger detector. The at least one indicator device may in particular comprise at least one light source, such as an LED, that is activated in response to receiving the detection signal from the at least one passenger detector for indicating the presence of at least one passenger in the detection range of the at least one passenger detector.

Exemplary embodiments of the invention include a method of indicating at at least one landing of an elevator system that at least one passenger is present in an elevator car of the elevator system, wherein the method includes: detecting the presence of the at least one passenger in the elevator car using a passenger detector that is located in the elevator car; transmitting a detection signal indicating the presence of the at least one passenger in the elevator car from the passenger detector to at least one indicator device located at the at least one landing; and the at least one indicator device indicating that at least one passenger is present in the elevator car in response to receiving the detection signal from the passenger detector.

Exemplary embodiments of the invention further include a method of indicating in an elevator car of an elevator system that at least one passenger is present at at least one landing of the elevator system, wherein the method includes detecting that at least one passenger is present at at least one landing of the elevator system using a passenger detector that is located at the respective landing; transmitting a detection signal indicating that the at least one passenger is present at the at least one landing from the passenger detector to an indicator device located in the elevator car; and the at least one indicator device indicating that at least one passenger is present at the at least one landing of the elevator system in response to receiving the detection signal from the passenger detector.

The method may in particular include detecting and indicating the presence of at least one passenger at every landing of the elevator system.

Alternatively, the method may include detecting and indicating only the presence of at least one passenger that is present at the landing that is to be served next by the elevator car.

Methods according to exemplary embodiments of the invention may include detecting that at least one passenger is present at the at least one landing of the elevator system by detecting IR radiation emitted by the at least one passenger and/or by detecting movement of the at least one passenger. The methods may in particular include enhancing the reliability of the detection by detecting IR radiation emitted by the at least one passenger and by detecting movement of the at least one passenger and combining the results of the two detection methods.

Methods according to exemplary embodiments of the invention may include transmitting the detection signals from the one passenger detector to the at least one indicator device via a wired data connection or via a wireless data connection.

The additional features, modifications and effects that have been described with respect to elevator systems comprising a passenger detection system according to exemplary embodiments of the invention apply to the above mentioned methods of detecting passengers in an elevator system in an analogous manner.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIG. 2 depicts an explosive view of such a box of a passenger detection system comprising a passenger detector and a passenger indicator device.

FIG. 3A depicts an exemplary embodiment of an elevator car control panel that is equipped with a detector-indicator interface comprising an elevator car passenger detector and an elevator car indicator device.

FIG. 3B depicts an enlarged view of the detector-indicator interface depicted in FIG. 3A.

FIG. 4A depicts an exemplary embodiment of an elevator car control panel that is equipped with a covering, an elevator car passenger detector and an elevator car indicator device.

FIG. 4B depicts an enlarged view of the display and the display frame depicted in FIG. 4A.

FIG. 4C depicts an enlarged view of a further embodiment of a display and a display frame.

### DETAILED DESCRIPTION OF THE INVENTION

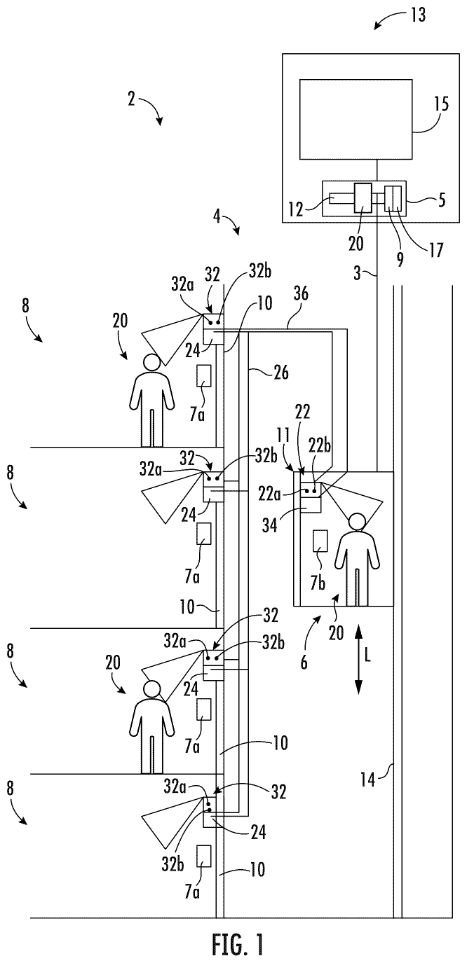

FIG. 1 schematically depicts an elevator system 2 according to an exemplary embodiment of the invention.

The elevator system 2 comprises a hoistway 4 extending in a longitudinal direction L between a plurality of landings 8 located on different floors. The elevator system 2 includes an elevator car 6 that is arranged in the hoistway 4 for being moved along the longitudinal direction L between the plurality of landings 8. The elevator car 6 may in particular be movable along at least one elevator car guide member 14, such as at least one elevator car guide rail, provided in the hoistway 4 and extending along the longitudinal direction L.

The longitudinal direction L may be oriented in a vertical direction, as it is depicted in FIG. 1. In an alternative embodiment not depicted in the figures the longitudinal direction L may be inclined with respect to the vertical direction.

Although only a single elevator car guide member 14 is visible in FIG. 1, the elevator system 2 may comprise a plurality of elevator car guide members 14.

Although only a single elevator car 6 is depicted in FIG. 1, exemplary embodiments of the invention may also include elevator systems 2 comprising a plurality of elevator cars 6 moving in one or more hoistways 4.

The elevator car 6 is movably suspended by means of a tension member 3. Although only a single tension member 3 is depicted in FIG. 1, exemplary embodiments of the invention may also include elevator systems 2 comprising a plurality of tension members 3.

The at least one tension member 3, for example a rope or belt, is coupled to an elevator drive system 5. The elevator drive system 5 comprises a motor 9 for rotatably driving a shaft 12, and a drive 17 that harnesses and controls the electrical energy supplied to the motor 9. The elevator drive system 5 is configured for driving the at least one tension member 3, which is coupled to the shaft 12 via traction, in order to move the elevator car 6 in the hoistway 4 along the longitudinal direction L between the plurality of landings 8.

The elevator drive system 5 is further provided with at least one elevator brake 19 for braking rotation of the shaft 12 in order to allow for stopping movement of the elevator car 6.

Optionally, the elevator system 2 may comprise an elevator counterweight that is not depicted in FIG. 1. The elevator counterweight may be attached to the at least one tension member 3 opposite to the elevator car 6 and configured for moving concurrently and in opposite direction with respect to the elevator car 6. The elevator counterweight may move along at least one elevator counterweight guide member, which is also not shown in FIG. 1.

The at least one tension member 3 may be a rope, e.g. a steel cord, or a belt, in particular a coated steel belt. The at least one tension member 3 may be uncoated. Alternatively, the at least one tension member 3 may be coated with a coating, e.g. with a coating having the form of a polymer jacket. In a particular embodiment, the at least one tension member 3 may be a belt comprising a plurality polymer coated steel cords (not shown). The elevator system 2 may have a traction drive including a traction sheave for driving the at least one tension member 3.

In the exemplary embodiment shown in FIG. 1, a 1:1 roping is employed for suspending the elevator car 6. The type of the roping is, however, not essential for the invention and different kinds of roping, e.g. a 2:1 roping or a 4:1 roping may be employed as well.

At least one landing door 10 is provided at each of the landings 8. The elevator car 6 is provided with at least one corresponding elevator car door 11 for allowing passengers to transfer between a landing 8 and the interior of the elevator car 6, when the elevator car 6 is positioned at the respective landing 8.

Two or more landing doors 10 may be provided at at least one of the landings 8, and the elevator car 6 may be provided with two or more corresponding elevator car doors 11 for allowing passengers to enter and exit the elevator car 6 from nd to different sides.

For moving the elevator car 6 along the hoistway 4 between the different landings 8, the elevator drive system 5 may be controlled by an elevator controller 15 of the elevator system 2.

The elevator system 2 may be a machine room-less elevator system 2. In an alternative embodiment, the elevator system 2 may comprise a machine room 13 housing the elevator drive system 5 and the elevator controller 15.

Input to the elevator controller 15 may be provided via landing control panels 7a provided on every landing 8, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be connected to the elevator controller 15 by means of electrical wiring not shown in FIG. 1, in particular by an electric bus, or by wireless data connections.

The elevator system 2 depicted in FIG. 1 is equipped with a passenger detection system for informing passengers 20 in the elevator car 6 about the presence of passengers 20 waiting at the landings 8 as well as for informing passengers 20 waiting at the landings about the presence of passengers 8 in the elevator car 6.

The passenger detection system comprises an elevator car passenger detector 22 located in the elevator car 6 and configured for detecting the presence of at least one passenger 20 in the elevator car 6.

The passenger detection system further comprises at least one landing indicator device 24 provided at at least one of the landings 8 and configured for indicating that at least one passenger 20 is present in the elevator car 6 in case the elevator car passenger detector 22 detected the presence of at least one passenger 20 in the elevator car 6.

In the exemplary embodiment depicted in FIG. 1, a landing indicator device 24 is provided at every landings 8, respectively. In consequence, the presence of at least one passenger 20 in the elevator car 6 may be indicated to passengers 20 at every landing 8.

In an alternative embodiment, a landing indicator device 24 may be provided only at a number of selected landings 8, in particular only at a single landing 8, for example only at the lowest landing 8.

In an embodiment, the passenger detection system is configured for indicating the presence of at least one passenger 20 in the elevator car 6 at every landing. In an alternative embodiment, the passenger detection system is configured for indicating the presence of at least one passenger 20 in the elevator car 6 only at the landing 8 that will be served next by the elevator car 6.

The passenger detection system depicted in FIG. 1 further comprises multiple landing passenger detectors 32 located at the landings 8 and configured for detecting the presence of at least one passenger 20 at the respective landing 8.

The passenger detection system also comprises an elevator car indicator device 34 provided in the elevator car 6. The elevator car indicator device 34 is configured for indicating that at least one passenger 20 is present at at least one of the landings 8 upon receiving an indicator signal indicating the presence of at least one passenger 20 at one of the landings 8 from at least one of the elevator car indicator devices 34.

In the exemplary embodiment depicted in FIG. 1, landing passenger detectors 32 are provided at every of the landings 8, so that the presence of at least one passenger 20 may be detected at every landing 8.

In an alternative embodiment, a landing passenger detector 32 may be provided only at a number of selected landings 8, in particular only at a single landing 8, for example only at the lowest landing 8.

In an embodiment, the elevator car indicator device 34 may be configured for indicating the presence of at least one passenger 20 in case at least one passenger 20 is present at any of the landings 8. In an alternative embodiment, the elevator car indicator device 34 may be configured for indicating the presence of at least one passenger 20 only if the at least one passenger 20 is present at the landing 8 that is to be served next by the elevator car 6.

The elevator car passenger detector 22 and the landing indicator devices 24 are coupled with each other by a first data connection 26 that allows for transmitting indicator signals indicating the presence of at least one passenger 20 in the elevator car 6 from the elevator car passenger detector 22 to the landing indicator devices 24.

The landing passenger detectors 32 and the elevator car indicator device 34 are coupled with each other by a second data connection 36 that allows for transmitting indicator signals indicating the presence of at least one passenger 20 at the respective landing 8 from the landing passenger detectors 32 to the elevator car indicator device 34.

The first and second data connections 26, 36 may be wired data connections comprising electrical wires extending between the elevator car passenger detector 22 and the landing indicator devices 24 or between the landing passenger detectors 32 and the elevator car indicator device 34, respectively. The data connections 26, 36 may be implemented as a bus, in particular as a CAN bus.

A common data connection 26, 36, in particular a bidirectional bus, may be employed for transmitting indicator signals from the elevator car passenger detector 22 to the landing indicator devices 24 and for transmitting indicator signals from the landing passenger detectors 32 to the elevator car indicator device 34.

Optionally, the same data connection 26, 36 may be used additionally for transmitting elevator control signals from the landing control panels 7a to the elevator controller 15.

Using a single connection 26, 36 for transmitting multiple signals may allow for reducing the wiring and in consequence the costs of the elevator system 2.

Alternatively, separate data connections 26, 36 may be employed for transmitting the indicator signals and for transmitting elevator controlled signals from the control panels 7a, 7b to the elevator controller 15, respectively. Providing separate data connections 26, 36 may allow for operating the passenger detection system independently of the elevator system 2. This may enhance the operations reliability of the elevator system 2.

In a further embodiment, the data connections 26, 36 may be wireless data connections comprising a transmitter at the respective passenger detector 22, 32 and receivers at the indicator devices 24, 34 for transmitting the indicator signals from the passenger detectors 22, 32 to the indicator devices 24, 34.

Using wireless data connections avoids the need of providing wiring for transmitting the indicator signals from the passenger detector 22, 32 to the indicator devices 24, 34. This may facilitate the installation of the passenger detectors 22, 32 and the indicator devices 24, 34.

Using wireless data connections may in particular facilitate adding a passenger detection system to an existing elevator system 2.

The wireless data connections may be implemented using WLAN, Bluetooth, or a similar technology.

The exemplary embodiment of an elevator system 2 depicted in FIG. 1 comprises a bidirectional passenger detection system, i.e. a passenger detection system that allows for detecting and indicating that at least one passenger 20 is present at at least one of the landings 8 as well as detecting and indicating that at least one passenger 20 is present in the elevator car 6.

Exemplary embodiments of the invention further include elevator systems 2 that are equipped only with a mono-directional passenger detection system, i.e. with a passenger detection system comprising only a single elevator car passenger detector 22 that is located in the elevator car 6 and configured for detecting that at least one passenger 20 is present in the elevator car 6 and at least one landing indicator device 24 that is located at at least one of the landings 8 and configured for indicating that at least one passenger 20 is present in the elevator car 6.

In an alternative embodiment, a mono-directional passenger detection system comprises only at least one landing passenger detector 32 that is located at at least one of the landings 8 and configured for detecting that at least one passenger 20 is present at the respective landing 8, and an elevator car indicator device 34 that is provided in the elevator car 6 and configured for indicating that at least one passenger 20 is present at at least one of the landings 8.

Each of the passenger detectors 22, 32 depicted in FIG. 1 may comprise a motion detector 22a, 32a that is configured for detecting the movement of a passenger 20 in its detection range, and/or an infrared detector 22b, 32b that is configured for detecting infrared radiation emitted by a passenger 20 that is present in its detection range of the respective infrared detector 22b, 32b.

For enhancing the reliability of the detection, the passenger detectors 22, 32 may comprise both, a motion detector 22a, 32a and an infrared detector 22b, 32b. The passenger detectors 22, 32 may in particular comprise a combined motion and infrared detector, such as a TMOS sensor.

A TMOS detector is an active and uncooled sensor that is able to detect the thermal radiation emitted by an object located in the field of view of the sensor. A TMOS detector provides a very reliable detector for detecting the presence of at least one passenger in the elevator car or at a landing. A TMOS detector may have small dimensions and may be provided at low costs.

One of the passenger detectors 22, 32 and one of the indicator devices 24, 34 may be installed in a box 40, in particular in a dedicated passenger detection system box 40, that may be installed in the elevator car 6 or at one of the landings 8.

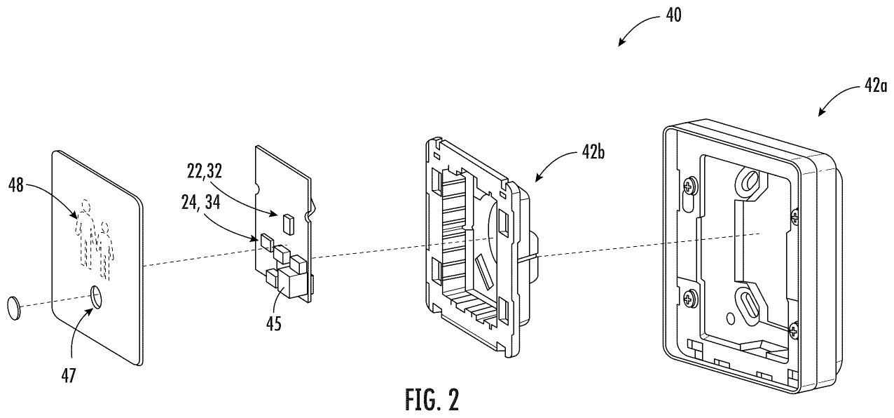

FIG. 2 depicts an explosive view of such a box 40, which may be installed in an elevator system 2 according to an exemplary embodiment of the invention.

The box 40 comprises a housing 42a, 42b for accommodating a carrier 44, in particular a circuit board, more particularly a printed circuit board (PCB). The carrier 44 supports a passenger detector 22, 32, such as a TMOS chip, and an indicator device 24, 34, for example an LED.

The carrier 44 may further support additional electronic components 45, such as a transmitter and a receiver that allow for communicating with other passenger detectors 22, 32 and indicator devices 32, 34 of the passenger detection system.

The box 40 further comprises a cover 46 that is configured for being mounted to the housing 42a, 42b for closing the box 40 and protection the carrier 44, the passenger detector 22, 32, the indicator device 24 and the additional electronic components 45 from adverse external influences.

The cover 46 comprises a least one indicator portion 48, which is at least partially transparent for allowing light emitted by the indicator device 24, 34 to pass through the cover 46. Optionally, the indicator portion 48 may comprise a symbol for symbolizing the presence of a passenger 20. When a passenger 20 is detected, the symbol may be illuminated from behind by light emitted by the indicator device 24, 34 for indicating the presence of the passenger 20.

The cover 46 may further comprise at least one detector portion 47. The passenger detector 22, 32 is arranged behind the at least one detector portion 47.

The at least one detector portion 47 may comprise an opening, or it may be made of a special material that is configured such that it allows the passenger detector 22, 32 to detect passengers 20 that are present outside the box 40 in the elevator car 6 or at the respective landing 8, respectively.

Alternatively, the complete cover 46 may be made of a material that allows the passenger detector 22, 32 to detect passengers 20 that are present outside the box 40. In this case, no special detector portion 47 needs to be provided in the cover 46 and the passenger detector 22, 32 may be installed at an arbitrary position behind the cover 46.

Installing such boxes 40 comprising a passenger detector 22, 32 and an indicator device 24, 34 in the elevator car 6 and/or at the landings 8 may be the easiest and fastest way for equipping an elevator system 2 with a passenger detection system. Installing such boxes 40 in the elevator car 6 and at the landings 8 allows in particular for conveniently adding a passenger detection system to an existing elevator system 2.

In a further embodiment, a passenger detector 22, 32 and an indicator device 34, 34 may be installed in a control panel 7a, 7b of the elevator system 2, i.e. in a landing control panel 7a provided at one of the landings 8 and/or in the elevator car control panel 7b provided in the elevator car 6.

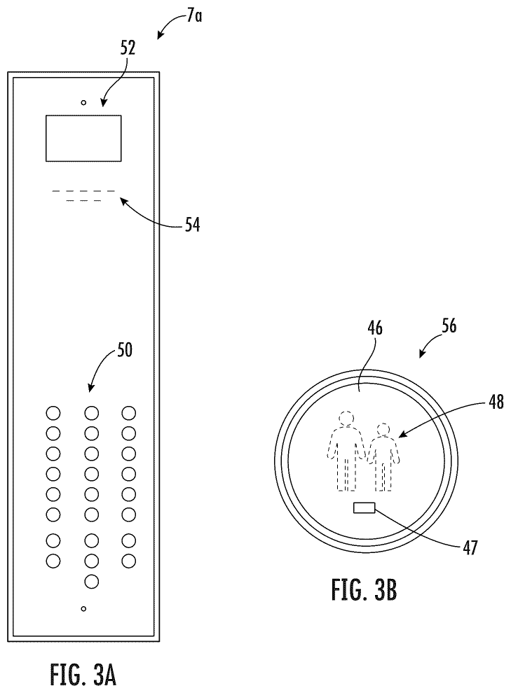

FIG. 3A depicts an exemplary embodiment of an elevator car control panel 7b that is equipped with an elevator car passenger detector 22 and with an elevator car indicator device 34.

The elevator car control panel 7b depicted in FIG. 3A comprises a plurality of control buttons 50 that allow for inputting control commands into the elevator controller 15 in order to control the operation of the elevator system 2.

The elevator car control panel 7b further comprises a display 52 that allows for displaying visual information to passengers 20 in the elevator car 6, and a loudspeaker/microphone 54 that allows for acoustic communication with the passengers 20 in the elevator car 6.

In the embodiment depicted in FIG. 3A, the control buttons 50 are arranged in a rectangular matrix pattern. Other arrangements of the control buttons 50 are possible as well.

In one position of the pattern, one of the control buttons 50 is replaced by a detector-indicator interface 56 of the passenger detection system. The detector-indicator interface 56 is basically a small version of the box 40 depicted in FIG. 2, comprising a carrier (not shown), in particular a circuit board, more particularly a printed circuit board (PCB), supporting an elevator car passenger detector 22 and an elevator car indicator device 24, which are also not visible in FIG. 3A.

FIG. 3B shows an enlarged view of the detector-indicator interface 56.

The detector-indicator interface 56 comprises a cover 46 including a least one indicator portion 48, which is at least partially transparent for allowing light emitted by the elevator car indicator device 24 to pass through the cover 46.

Optionally, the indicator portion 48 may comprise a symbol for symbolizing the presence of a passenger 20. When a passenger 20 is detected, the symbol may be illuminated from behind by light emitted by the indicator device 24, 34 for indicating the presence of the passenger 20.

The cover 46 may further comprise at least one detector portion 47. The passenger detector 22, 32 is arranged behind the at least one detector portion 47.

The at least one detector portion 47 may comprise an opening, or it may be made of a special material that is configured such that it allows the passenger detector 22, 32 to detect passengers 20 that are present in the elevator car 6 or at the respective landing 8, respectively.

Alternatively, the complete cover 46 may be made of a material that allows the passenger detector 22, 32 to detect passengers 20 that are present in the elevator car 6 or at the respective landing 8, respectively. In this case, no special detector portion 47 needs to be provided in the cover 46 and the passenger detector 22, 32 may be installed at an arbitrary position behind the cover 46.

Although it is not explicitly depicted in the figures, the skilled person understands that a detector-indicator interface 56, as it is depicted in FIG. 3, may similarly be installed in a landing control device 7a of the elevator system 2.

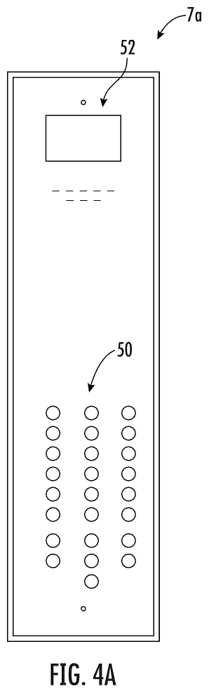

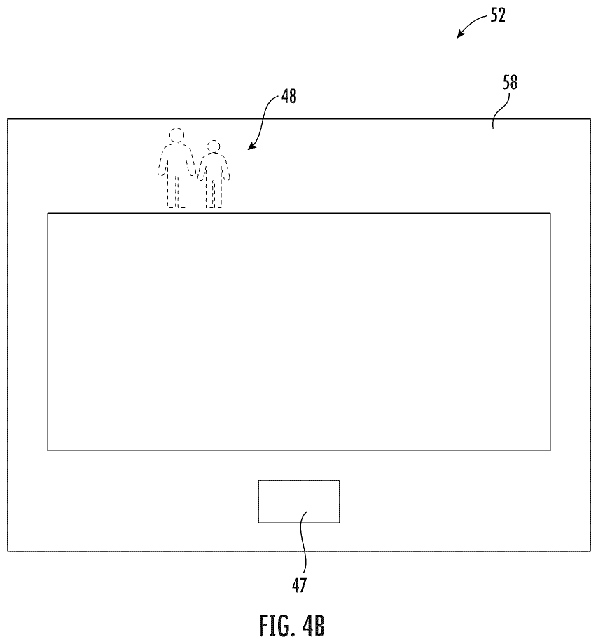

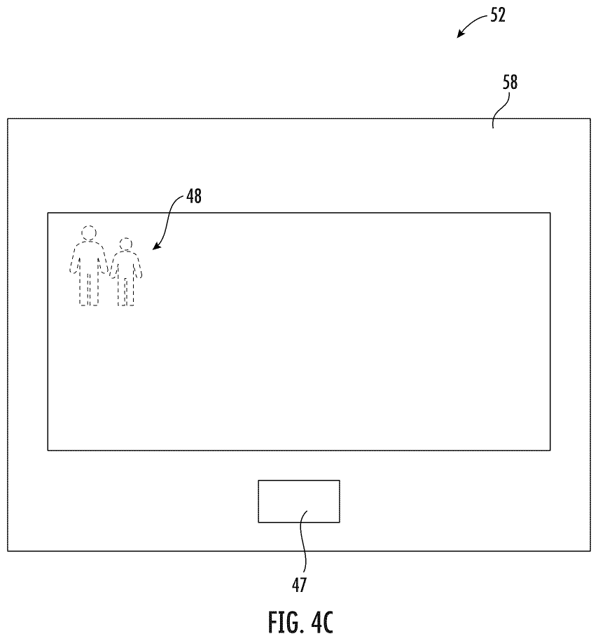

FIG. 4A depicts an exemplary embodiment of another embodiment of an elevator car control panel 7b that is equipped with an elevator car passenger detector 22 and with an elevator car indicator device 34.

Similar to the elevator car control panel 7b depicted in FIG. 3A, the elevator car control panel 7b depicted in FIG. 4A comprises a plurality of control buttons 50 that allow inputting control commands for controlling the operation of the elevator system 2.

The elevator car control panel 7b further comprises a display 52 that allows for displaying visual information to passengers 20 in the elevator car 6, and a loudspeaker/microphone 54 that allows for acoustic communication with the passengers 20 in the elevator car 6.

In the embodiment depicted in FIG. 4A, the display 52 comprises a display portion 60 that is surrounded by a display frame 58. The elevator car passenger detector 22 and the elevator car indicator device 34 are installed behind the display frame 58. In consequence, the elevator car passenger detector 22 and the elevator car indicator device 34 are not visible in FIG. 4A.

FIG. 4B depicts an enlarged view of the display 52 with the display portion 60 surrounded by the display frame 58.

Similar to detector-indicator interface 56 depicted in FIG. 3B, the display frame 58 comprises an indicator portion 48 that is at least partially transparent for allowing light that is emitted by the elevator car indicator device 24 arranged behind the display frame 58 to pass through the display frame 58.

Optionally, the indicator portion 48 may comprise a symbol for symbolizing the presence of a passenger 20. When a passenger 20 is detected, the symbol may be illuminated from behind by light emitted by the indicator device 24, 34 for indicating the presence of the passenger 20.

The display frame 58 may further comprise at least one detector portion 47. The passenger detector 22, 32 is arranged behind the at least one detector portion 47.

The at least one detector portion 47 may comprise an opening, or it may be made of a special material that is configured such that it allows the passenger detector 22, 32 to detect passengers 20 that are present in the elevator car 6 or at the respective landing 8, respectively.

Alternatively, the complete display frame 58 may be made of a material that allows the passenger detector 22, 32 to detect passengers 20 that are present in the elevator car 6 or at the respective landing 8, respectively. In this case, no special detector portion 47 needs to be provided in the display frame 58 and the passenger detector 22, 32 may be installed at an arbitrary position behind the display frame 58.

FIG. 4C depicts an enlarged view of a further embodiment of a display 52 comprising a display portion 60 and a display frame 58. In the embodiment depicted in FIG. 4C, the indicator portion 48 is not provided in the display frame 58, but in the display portion 60 of the display 52.

In yet another embodiment, the display 52 may be provided without a display frame 58.

Although it is not explicitly depicted in the figures, the skilled person understands that a display 52 comprising a displaying frame 58 with a landing passenger detector 32 and a landing indicator device 34 being arranged behind the display frame 58 may similarly added to a landing control device 7a of the elevator system 2.

In consequence, the elevator system 2 may be conveniently equipped with a passenger detection system without altering the visual appearance of the landings 8 and of the elevator car 6. This may be considered as beneficial from an aesthetic point of view.

Integrating the passenger detectors 22, 24 and the indicator devices 32, 34 into a control devices 7a, 7b may further allow for reducing the amount of wiring that is needed for wiring the passenger detectors 22, 24 and the indicator devices 32, 34. Reducing the amount of wiring may facilitate the installation of the passenger detectors 22, 24 and the indicator device 24, 34. It may further reduce the costs of such an installation.

In the exemplary embodiments depicted in the figures, the passenger detectors 22 and/or the indicator device 34 are located in or in the vicinity of the elevator car control panel 7b. In further embodiments that are not explicitly depicted in the figures, the passenger detectors and/or the indicator device 24 may be located at other positions in the elevator car 7, for example in the elevator car door frame, on top of the elevator car door frame, on the side door frame, or in another panel of the elevator car 6.

Similarly, the passenger detectors 32 and/or the indicator device 24 may be placed on the door frames of the landing doors 10 or on the wall around the landing door frame. The passenger detectors 32 and/or the indicator device 24 may also be placed in the landing control panels 7a, similar to the solution depicted in FIG. 3B.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling in the scope of the dependent claims.

What is claimed is:

1. Elevator system (2) comprising:
an elevator car (6) configured for travelling along a hoistway (4) between a plurality of landings (8); and
a passenger detection system including:
at least one passenger detector (22, 32) configured for detecting the presence of at least one passenger (20) in a detection range of the at least one passenger detector (22, 32) and for providing a detection signal if it detects the presence of at least one passenger (20) in the detection range of the at least one passenger detector (22, 32; and
at least one indicator device (24, 34) configured for
receiving the detection signal from the at least one passenger detector (22, 32) indicating the presence of at least one passenger (20) in the detection range of the at least one passenger detector (22, 32), and for
outputting a notification indicating that at least one passenger (20) is present in the detection range of the at least one passenger detector (22, 32) in response to receiving the detection signal from the at least one passenger detector (22, 32);
wherein the at least one passenger detector (22, 32) is located in the elevator car (6) and/or at at least one of the landings (8) of the elevator system (2); and
wherein the at least one indicator device (24, 34) is located at the other one of the elevator car (6) and/or the at least one of the landings (8) of the elevator system (2) so that the detection signal is transmitted from the at least one of the landings (8) to the elevator car (6) and/or from the elevator car (6) to the at least one of the landings (8).

2. Elevator system (2) according to claim 1, wherein the passenger detection system, comprises:
an elevator car passenger detector (22) that is located in the elevator car (6) and configured for detecting that at least one passenger (20) is present in the elevator car (6), and at least one landing indicator device (24) that is located at the at least one of the landings (8) and configured for indicating that at least one passenger (20) is present in the elevator car (6); and
at least one landing passenger detector (32) that is located at the at least one of the landings (8) and configured for detecting that at least one passenger (20) is present at the at least one of the landings (8), and an elevator car indicator device (34) that is located in the elevator car (6) and configured for indicating that at least one passenger (20) is present at the at least one of the landings (8).

3. Elevator system (2) according to claim 1,
wherein each landing (8) of the plurality of landings (8) is provided with a passenger detector (22, 32); and/or
wherein each landing (8) of the plurality of landings (8) is provided with an indicator device (24, 34).

4. Elevator system (2) according to claim 3,
wherein the indicator device (34) located at the elevator car (6) is configured for indicating the presence of at least one passenger (20) at any of the plurality of landings (8) of the elevator system (2); or
wherein the indicator device (34) located at the elevator car (6) is configured for indicating the presence of at least one passenger (20) only at that landing (8) among the plurality of landings (8) that is to be served next by the elevator car (6).

5. Elevator system (2) according to claim 1,
wherein the at least one passenger detector (22, 32) comprises a motion detector (22a, 32a) and/or an infrared detector (22b, 32b); wherein the at least one passenger detector (22, 32) comprises in particular a combined motion and infrared detector; and/or
wherein the at least one indicator device (32, 34) is an optical indicator device (32, 34) comprising at least one light source, such as an LED, that is activated in response to receiving the detection signal from the at least one passenger detector (22, 32).

6. Elevator system (2) according to claim 1, wherein the elevator system (2) comprises at least one box (40), in particular in a dedicated passenger detection system box (40), located in the elevator car (6) or at the respective landing (8), with each box (40) accommodating one of the at least one passenger detectors (22, 32) and/or one of the at least one indicator devices (24, 34), respectively.

7. Elevator system (2) according to claim 1, wherein the at least one passenger detector (22, 32) and/or the at least one indicator device (24, 34) are located in an elevator control panel (7a, 7b) located in the elevator car (6) or at the respective landing (8).

8. Elevator system (2) according to claim 1, wherein the at least one passenger detector (22, 32) and/or the at least one indicator device (24, 34) are located in a frame (58) or in a display portion (60) of a display (52) provided in the elevator car (6) or at the respective landing (8).

9. Elevator system (2) according to claim 1, wherein the at least one passenger detector (22, 32) and the at least one indicator device (24, 34) are coupled with each other by a wired data connection (26, 36) for transmitting the detection signal from the at least one passenger detector (22, 32) to the at least one indicator device (24, 34); wherein the wired data connection (26, 36) includes in particular a communication bus, for example a CAN bus.

10. Elevator system (2) according to claim 1, wherein the at least one passenger detector (22, 32) and the at least one indicator device (24, 34) are configured for transmitting the detection signal from the at least one passenger detector (22, 32) to the at least one indicator device (24, 34) via a wireless data connection, wherein the wireless data connection includes in particular a WLAN connection or a Bluetooth connection.

11. Elevator system (2) according to claim 1, wherein the at least one indicator device (24, 34) is configured for outputting an optical signal and/or an acoustic signal for indicating the presence of at least one passenger (20) in the detection range of the at least one passenger detector (22, 32).

12. Method of indicating at at least one landing (8) of an elevator system (2) that at least one passenger (20) is present in an elevator car (6) of the elevator system (2), wherein the method includes:
detecting the presence of the at least one passenger (20) in the elevator car (6) using an elevator car passenger detector (22) that is located in the elevator car (6);
transmitting a detection signal indicating the presence of the at least one passenger (20) in the elevator car (6) from the elevator car passenger detector (22) to at least one landing indicator device (24) located at the at least one landing (8); and
the at least one landing indicator device (24) indicating that at least one passenger (20) is present in the elevator car (6) in response to receiving the detection signal from the at least one elevator car passenger detector (22).

13. Method of indicating in an elevator car (6) of an elevator system (2) that at least one passenger (20) is present at at least one landing (8) of the elevator system (2), wherein the method includes:
detecting that at least one passenger (20) is present at at least one landing (8) of the elevator system (2) using a landing passenger detector (32) that is located at the respective landing (8);
transmitting a detection signal indicating that the at least one passenger (20) is present at the at least one landing (8) of the elevator system (2) from the landing passenger detector (32) to an elevator car indicator device (34) in the elevator car (6); and
the elevator car indicator device (34) indicating that at least one passenger (20) is present at the at least one landing (8) of the elevator system (2) in response to receiving the detection signal from the landing passenger detector (32).

14. Method according to claim 13, wherein the method includes detecting and indicating the presence of at least one passenger (20) at every landing (8) of the elevator system (2); or
detecting and indicating only the presence of at least one passenger (20) that is present at the landing (8) that is to be served next by the elevator car (6).

15. Method according to claim 12,
wherein detecting that at least one passenger (20) is present at the at least one landing (8) of the elevator system (2) includes detecting IR radiation emitted by the at least one passenger (20) and/or detecting movement of the at least one passenger (20); and/or
wherein the detection signal is transmitted from the at least one passenger detector (22, 32) to the at least one indicator device (24, 34) via a wired data connection (26, 36) or via a wireless data connection.
